(19) United States
(12) Patent Application Publication
(10) Pub. No.: US 2008/0227484 A1
(43) Pub. Date: Sep. 18, 2008

(54) Method for Modifying Service Mode Requested by a Communications Terminal

(75) Inventors: Vincent Auvray, Caen (FR); Christophe Beziau, Saint-Martin de Fontenay (FR); Bertrand Collomb-Patton, Boulon (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: France Telecom, Paris (FR)

(21) Appl. No.: 11/915,236

(22) PCT Filed: Jun. 13, 2006
(86) PCT No.: PCT/EP06/63139

§ 371 Date: May 8, 2008

(30) Foreign Application Priority Data
Jun. 13, 2005 (FR) 0505972

(51) Int. Cl. H04M 1/00

(52) U.S. Cl. 455/552.1

(57) ABSTRACT

A method and apparatus are provided for modifying a service mode requested by a communication and/or broadcasting terminal. The terminal is connected to a communication network with a variable quality of service. The terminal executes at least the following steps, prior to transmitting at least some of its requests: selecting a new identifier value of the desired service mode; and integrating in the content of the request to be transmitted, the identifier value of said desired service mode, such that the signals required by the terminal are adapted to a format corresponding to the identifier value contained in the request.

### CROSS-REFERENCE TO RELATED APPLICATIONS

This Application is a Section 371 National Stage Application of International Application No. PCT/EP2006/063139, filed Jun. 13, 2006, and published as WO 2006/134102A1 on Dec. 21, 2006, not in English.

### FIELD OF THE DISCLOSURE

The field of the disclosure is that of the mobile telecommunications and of access through one and the same mobile terminal to several types of contents taking the form of multimedia data, for example video, text, audio and other data using a determined navigation interface.

More specifically, the context of the disclosure is that of a problem of adaptation of a navigation interface of this kind according to the type and availability of the communications network used at a given point in time.

Indeed, the availability of bandwidth in communications networks used to support access to multimedia contents provided by remote content server terminals, and navigation in the multimedia data provided by these servers, varies in time according to the number of mobile terminals that are simultaneously connected to these servers.

Furthermore, each type of mobile communications network respectively, and by its nature, proposes a bit rate:
limited to 9.6 Kbit/s for communication in GSM DATA mode;
limited to between 30 to 40 Kbit/s in reception and between 10 to 20 Kbits/s in transmission for communication in GPRS mode;
practically constant at about 250 Kbit/s for communication in UMTS/3G mode;
capable of attaining Mbit/s for communications in WiFi mode, according to the standard.

These communications bit rates during data transfers and exchanges on these different types of mobile communications networks vary in certain cases according to the distance between the mobile terminal and the GSM/GPRS/3G relay or the WiFi hot spot, depending on reception quality or again depending on the type of mobile terminal used.

Thus, for obvious reasons of efficiency, economy and availability, it becomes necessary to drive the different services available above these transport layers depending on whether the network used is low-bit-rate (GSM DATA),/mean-bit-rate (GPRS) or high-bit-rate (UMTS/3G, WiFi) network. This is done by adapting the appropriate mode of navigation: WAP, light HTML, HTML, etc., depending on whether it is sought to access multimedia contents of varying richness, and depending on the network connection accessible to the mobile terminal: GSM data, GPRS data, 3G, EDGE, UMTS, or other networks for example.

It is understood that, while the disclosure can be applied to radiocommunications, it can easily and more generally be applied to communications and broadcasting, for example radio or satellite communications or broadcasting. It can therefore be applied to any communications terminal that has only one communications interface which can adapt to the quality of signal received at a given point in time.

### BACKGROUND OF THE DISCLOSURE

At present, and as illustrated in FIG. 1, the WAP/Web systems of navigation on mobile terminals (10) enable these terminals to dialog by means of a navigation and/or dialogue interface (11) (for example a Web navigator) with a remote server terminal (12) making several multimedia contents available in the form of a website (13) for example without taking account of the nature of the network physical layer (205)—GSM DATA, GPRS, UMTS/3G, etc.—especially in terms of bit rate.

By way of an illustrative example, relatively undeveloped mobile terminals (10, 11) most commonly use a WAP type navigation interface (which shall more generally be called a “navigator” here below) so as to be able to access and navigate in the content of dedicated WAP sites.

The contents (13) published in server terminals (12) accessible in a communications network (205) are most usually reworked by means of multi-publication tools (17) that enable the mobile terminal (10) to be interfaced with the content server terminal (12) hosting a web site (13) example.

Such tools (17) pick up the requests (18) transmitted by the terminal (10) to the server terminal (12), extract the value of the navigation interface identifier (commonly called a “user-agent”) of the mobile terminal (10) from the header of these requests and then, for the response, depending on this identifier value, adapt (19) a multimedia-content-rich HTML page into a content page adapted to the navigation interface (11) of the mobile terminal (10).

Certain improved multi-publication tools can also convert the contents made available by server terminals automatically according to predefined rules. Others use rules dedicated to a site hosted by a server and redefine the multimedia data of the site to be transmitted to the mobile terminal page by page, according to the screen size and capacities of the navigation interface of this mobile terminal.

A major drawback of these approaches for adapting a multimedia content hosted by a content server (a web server for example) relates to the fact that the mobile terminals of the new generation have display and processing capacities comparable to that of real Internet navigation stations.

Now, the capacities of wireless networks, chiefly in terms of bit rate for multimedia data transmission, are voluminous. For example, a GSM, GPRS, 3G, WiFi network most usually depends on the location of the mobile terminal at a given point in time.

Thus, 3G or WiFi type high-bit-rate networks, for example, available in built-up urban areas, will however not be available outside urban areas where they will be relayed by GSM/GPRS type networks which have lower capacity, especially in terms of bit rate and/or bandwidth.

Now the contents transmitted by a contents server are adapted by this server to the navigation interface embedded by the terminal.

Thus, the size of the contents transmitted to a 3G mobile terminal relying for its communications and/or Internet navigation on a 3G network could be relatively great without notable deterioration of the quality of service provided to the user of the mobile terminal.

However, a same content, if intended for a 2G mobile telephone having only capacities of access to networks proposing lower reception and transmission bit rates, will be readapted before transmission.

Another drawback of the prior art techniques is related to the fact that when an advanced mobile telephone, for example of the 3G type, moves and passes from a 3G type network coverage (for example) to a lower-capacity network coverage (GSM for example), while its user interrogates the multimedia content of a website hosted by a content server, the content sent back to it following these different requests will not be readapted, and the server will continue to send him the requested content in a manner adapted to a 3G terminal connected to a 3G network and not to a 3G mobile terminal connected to a lower-capacity network.

The result is thus an appreciable reduction in the quality of service offered to the user of the mobile telephone. By way of an example to illustrate such a consequence, navigation at low-bit-rate through a GSM data type network, which is the only one available and/or accessible in a given period of time, with a new generation mobile telephone could prove to be as chaotic as the use of a modem dating back to 10 years with an office computer.

### SUMMARY

A method is provided for modifying the service mode requested by a communications and/or broadcasting terminal (20), the terminal (20) being connected to a communications network (205) with variable quality of service. According to such a method, the terminal (20) advantageously prior to the transmission (26) of at least certain of its requests, executes at least:
a step (52, 202) of selection of a new identifier value of the desired service mode;
a step (54,203) of integration, in the content of the request to be transmitted, of the identifier value of said desired service mode. Thus, the signals requested by the terminal (20) in response to each of its requests are adapted to the format (200) corresponding to the value that they contain.

Advantageously, an embodiment of the invention can be applied to any type of service accessible to a terminal capable of adapting its behavior and quality of service offered to the user.

The term “service mode” designates the type of protocol used by the radiocommunications terminal during a communications session, for example the HTML, light HTML, WAP, and other protocols, or any other supported communications protocol.

Thus, depending on the protocol used by the terminal, the navigation interface of this terminal can be easily adapted, so as to dynamically optimize the rendering of the display on the screen of the terminal and thus provide better quality of service to the user.

As a simple illustrative and non-restrictive example, when the WAP mode of service of the radiocommunications terminal is used, it works during a communications session according to the WAP protocol.

Thus, a WAP navigator selected on the terminal (manually or dynamically depending on the service mode, in this case the WAP service mode) will directly and dynamically format multimedia information received by the terminal according to the WAP mode so as to optimize the display and/or the restitution of this information on the terminal screen accordingly.

Preferably, the selection step (52, 202) takes account of at least one parameter of configuration of the terminal (20) defined by the user. The user can indeed have available an interface for the configuration of his terminal, as illustrated in FIGS. 4a and 4b, so as to influence the behavior and specify the level of quality of service required by the user as a function of at least one network parameter, or else as a function of the services used in a given period, for example a bandwidth consuming video service.

In one variant of an embodiment of the method of the invention, the selection step (52,202) takes account of the value of at least one parameter representing the quality of the connection of the terminal (20) to the network (205), belonging to the group comprising at least:
the bandwidth of said network (205):
the jitter of said network (205);
the maximum bit rate of said network (205);
the mean error rate of a link (205).

It is of course clear that the selection step can take account simultaneously or else in a differentiated way of at least one configuration parameter and of at least one parameter representing the quality of the network connection.

Advantageously, the value of at least one parameter representing the quality of the connection of the terminal (20) to the network (205) is detected by the terminal (20) or is detected by another remote terminal belonging to the group comprising at least:
a contents server;
a web server;
a network traffic supervision terminal.

Indeed, in the case of a mobile communications terminal, the passage from a 3G reception mode to a GSM reception mode can be initiated from a piece of information either contained in a frame received by the mobile terminal or directly detected by the mobile terminal.

Preferably, the method of an embodiment of the invention comprises:
in addition a step (51) of detection of the current value of at least one of the parameters representing the quality of the connection of the terminal (20) to the network (205);
   the step (52,202) of selection of a new identifier value of the desired service mode being adapted to the current value of at least one of the network parameters detected (205) when the identifier value of the service mode is different from the identifier value of the active service mode.

This selection is made from a list (25) of service modes that can be activated and used by the terminal (20), the list setting up a correspondence of ranges of values associated with at least certain of the network parameters with an identifier value of a service mode adapted to these ranges of values.

The new identifier value of the selected service mode is then integrated into the content of the request to be transmitted to the server at the step (54) of integration (203).
It is necessary to be able to adapt the response received from the terminal (20), following the sending of certain of its requests, to said new selected identifier value.

Advantageously, the step (52, 202) of selection of a new identifier value of the desired service mode comprises a sub-step (53) of replacement of the current navigation interface identifier value of the terminal (20) by a new navigation interface value adapted to the new identifier value of the service mode.

For the family of web applications, the navigation interface identifier is represented by the “user-agent” parameter.

It must be specified however that this identifier of the service mode will be represented by other categories of parameters for other types of families of embedded customer applications requiring the adaptation of their behavior and/or of the level of quality of service rendered, for example as a function of the bandwidth available at a given point in time on the communications network used.

Preferably, the sub-step of replacement is a sub-step (53) of replacement in the registry of the terminal (20) of the current navigation interface identifier value by the new navigation interface identifier value.

It will be specified here that the method of an embodiment of the invention is not applicable solely to terminals having several types of navigation and/or communications interfaces, which can be activated as a function of parameters of configuration and/or availability of the network connection at a given point in time, but also to terminals that have only one type of navigation and/or communications interface. Indeed, it must be considered that, depending on the geographical position of the terminal at a given point in time, relative to the location of the station with which the terminal communicates, the signal received by the terminal could be more or less degraded, thus requiring that the terminal switch from one service mode to another service mode more suited to the quality of the signal received.

Advantageously, the method of an embodiment of the invention comprises an additional step (55) for rebooting the navigation interface of said terminal (20) so as to activate the new navigation interface identifier value and be able to integrate this value into the content of the request to be transmitted to the server.

Preferably, the step (54, 203) of integration of the identifier value of the desired service mode into the content of the request to be transmitted is done in real time by a server module embedded in the terminal, the server module having preliminarily intercepted a request, prior to the transmission of this request by the terminal (20) to the server.

Thus, the format of the response of the server to the terminal (20) is perfectly suited to the new identifier value of the desired service mode.

In one alternative embodiment of the invention, the step (52, 202), for selection of a new identifier value of the desired service mode advantageously comprises a sub-step (50) for taking account of a set of predefined modification rules defining the modalities of replacement of the identifier value of the current service mode by the new identifier value of the service mode as a function of at least one service use parameter defined preliminarily by the user of the terminal.

Indeed, depending on whether the user seeks to access varyingly rich multimedia contents, he will of his own accord specify through a configuration interface of his terminal which type of service he wishes to receive or exploit, for example the WAP service, light HTML, HTML services, for example on the basis of his own appreciation of the ratio between quality of display and richness of service that it will be possible to obtain for a given level of availability of the network connection.

An embodiment of the invention also relates to a device for modifying the service mode asked for by a communications and/or broadcasting terminal (20), the terminal (20) being connected to a communications network (205) with variable quality of service and comprising means of transmission (26) of requests to a distant server.

Such a device according to an embodiment of the invention advantageously comprises at least the following means:
of selection (202) of a new identifier value of the desired service mode;
of integration (203), in the content of the request to be transmitted, of said identifier value of said desired service mode.
   The signals requested by the terminal (20) must be adapted to the format (200) corresponding to the identifier value contained in each request (26) of the terminal (20).

In an advantageous embodiment of the invention, the selection means (202) comprise means for taking account of at least one parameter of configuration of the terminal (20) defined by the user.

In one variant of an embodiment of the invention, the selection means (202) comprise means for taking account of the value of at least one parameter representing the quality of the connection of the terminal (20) to the network (205), belonging to the group comprising at least:
the bandwidth of said network (205):
the jitter of said network (205);
the maximum bit rate of said network (205);
the mean error rate of a link (205).

Preferably, the device of an embodiment of the invention furthermore comprises additional means:
of detection of the current value of at least one of the parameters representing the quality of the connection of the terminal (20) to the network (205);
of selection (202) of a new identifier value of the desired service mode adapted to the current value of at least one of the network parameters (205) detected, when the identifier value of the service mode is different from the identifier value of the active service mode. This selection is done from a list (25) of service modes that can be activated and used by the terminal (20), the list setting up a correspondence of ranges of values associated with at least certain of the network parameters with an identifier value of a service mode adapted to these ranges of values;
of integration (203), in the content of the request to be transmitted to the server, of the new identifier value of the selected service mode,
   so that the response received from said terminal (20) following the sending of certain of its requests is adapted to said new selected identifier value.

Preferably, the means of selection (202) of a new identifier value of the desired service mode comprise means of replacement of the current navigation interface identifier value of the terminal (20) by a new navigation interface value adapted to the new identifier value of the service mode.

Equally preferably, the means of replacement of the interface identifier value are means of replacement, in the registry of the terminal (20), of the current navigation interface identifier value by the new navigation interface identifier value.

It must be emphasized that, in an embodiment such as this of the device of the invention, one prerequisite relates to the navigation interface of the terminal used, which must be capable, without special modification, of receiving data in the WAP format as well as data in the HTML, light HTML or any other format.

Advantageously, the device according to an embodiment of the invention furthermore comprises self-adaptive means of configuration of the new identifier value of the desired service mode as a function of the current value of at least one parameter representing the quality of the connection of the terminal (20) to the network (205).

An embodiment of the invention also preferably relates to a communications and/or broadcasting terminal (20) comprising a plurality of activatable service modes and/or a plurality of communications interfaces with at least one contents server, through a communications network. According to an embodiment of the invention, such a terminal implements a device for modification of the current service mode as mentioned here above.

An embodiment of the invention also relates to a computer program product downloadable from a communications network and/or recorded in a computer-readable carrier and/or executable by a processor comprising program code instructions for the execution of the step of the above-mentioned method for modification of the service mode asked for by a communications and/or broadcasting terminal (20), the terminal (20) being connected to a communications network (205) with variable service quality when said program is executed on a computer.

The method of modification of the service mode asked for by a communications and/or broadcasting terminal (20) as previously described can advantageously be applied to the fields belonging to the group comprising at least:
videophony;
computer-assisted collaborative work;
embedded communicating applications;
messaging services;
television on demand;
video on demand.

It must be emphasized here that the method and device for modifying the service mode requested by a communications and/or broadcasting terminal according to an embodiment of the invention can easily be applied to any type of communications and/or broadcasting terminal, including a communications terminal capable of communicating with a local network, or again with a mobile broadcasting terminal.

Indeed, all the indications are that, in future, new mobile communications terminals, also compatible with the WiFi or Bluetooth (registered mark) standards or again the DVB-T standards will undergo the same problems of adaptation to the service mode used at a given point in time, according to variations in quality of network connection and/or availability of network connection in a particular geographical region.

### BRIEF DESCRIPTION OF THE DRAWINGS

Other features and advantages shall appear more clearly from the following description of a preferred embodiment of the invention, given by way of an illustrative and non-restrictive example, made with reference to the appended drawings, of which:

FIG. 1 already discussed in relation to the prior art, illustrates an example of distributed architecture in which a mobile terminal accesses a website hosted by server through a multi-publication tool.

FIG. 2 presents the general principle of a first embodiment of the invention entailing a modification of the identifier value of a current navigation interface of a mobile terminal, in the registry of this terminal;

FIG. 3 illustrates the general principle of a second possible embodiment of the invention, implementing a dynamic modification of the navigation interface identifier value in the header of the requests sent out by a mobile terminal;

FIGS. 4a and 4b respectively illustrate examples of interfaces of configuration of a navigation interface of a mobile telephone from a list of navigation interfaces that can be associated by a user with different network interfaces declared in the mobile terminal;

FIG. 5 is a flow chart of the major steps of the method of automatic adaptation of a navigation interface of a mobile radiocommunications terminal, according to an embodiment of the invention.

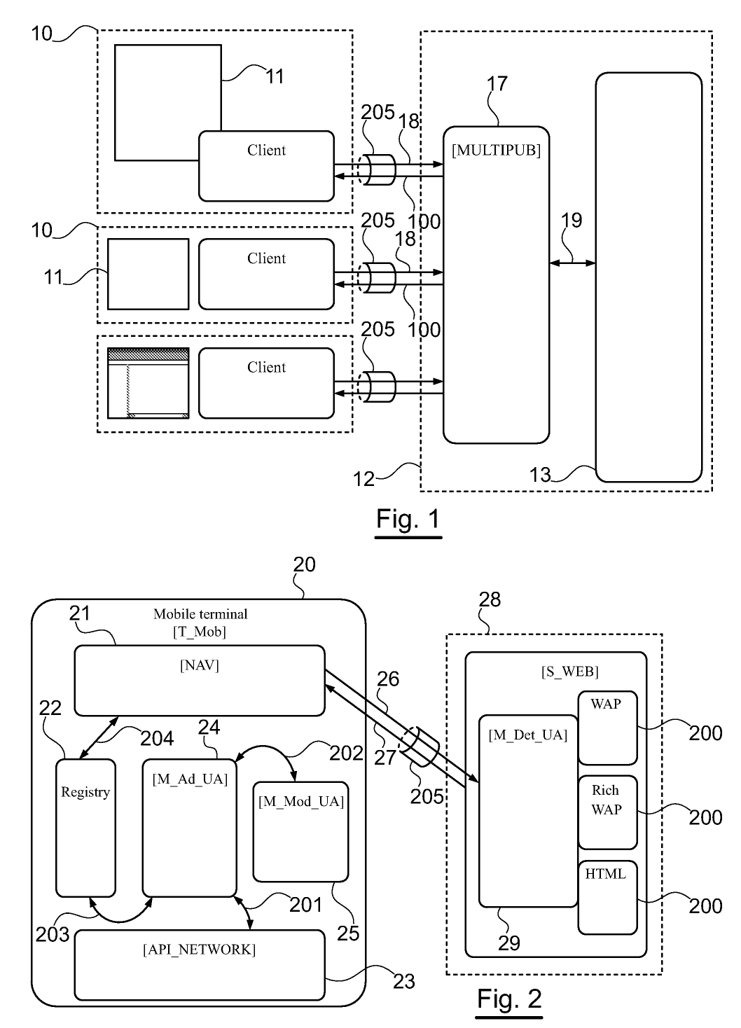

### DETAILED DESCRIPTION OF ILLUSTRATIVE EMBODIMENTS

An embodiment of the present invention therefore relates to a method for the automatic adaptation of a navigation interface of a mobile radiocommunications terminal comprising several types of navigation interfaces, the terminal being connected to a contents server by means of a connection to a communications network with variable service quality.

The originality of the method of an embodiment of the invention lies essentially in the way in which the user seeking access to the Internet via his mobile terminal is offered increased quality of service in the event of an unavailability of the high-bit-rate network in transmission and/or in reception, for example the 3G network.

The technique of an embodiment of the invention is based on an adaptation of the identifier value of the navigation interface of the terminal according to a level of bandwidth available in the network used at a given point of time, prior to the transmission of each request from the mobile terminal to a contents server, so that this server sends back the terminal a multimedia content that is perfectly adapted to its current navigation interface, this interface being itself perfectly adapted to the level of availability of the communications network used.

The navigation interface identifier is therefore transmitted to the content server in being integrated with each request sent out by the terminal. This navigation interface identifier of the terminal, commonly called a “user-agent” is embedded more specifically in the header of each request sent out by the mobile terminal to the contents server.

Other parameters, such as the version of the operating system, the screen size etc of the mobile telephone may also be embedded in the header of each request.

Internet sites hosted by contents servers have a plurality of different versions of the contents available which they offer to the mobile terminals (multi-published Internet site) so that they can adapt the contents sent back (description language, ergonomy, navigation, images, videos, audio, etc) in response to requests from the mobile terminals as a function of the value of the “user-agent” (UA) received from these terminals.

An embodiment of the invention thus proposes to give a mobile terminal the capacity to modify its UA according to the type of network connection it has available and/or according to the availability of such a network in terms of bit rates and/or bandwidth at a given point in time, so that the mobile terminal can receive the following:
light contents, of the basic black-and-white textual WAP type, for example if it has a GSM DATA type low-bit-rate connection;
richer contents, of the WAP type including color images, style-sheets etc, for example if it has a GPRS type mean-bit-rate connection;
contents 100% faithful to the content of the base site (HTML version for example) if it has available a high-bit-rate connection, for example of the 3G and/or WiFi type.

More specifically, an embodiment of the invention consists of the introduction of a module used to determine the best adapted network connection.

This module, embedded in the mobile terminal, has available functions of dialogue with the APIs of the lower layers of the terminal operating system.

It works in background task mode, so as to detect at regular intervals the nature of the network connection and the availability of the network in terms of bandwidth and bit rate at a given point in time and to modify accordingly the navigation interface identifier value used by the terminal, the goal being that of selecting a current navigation interface best suited to navigating in the multimedia content of a site hosted in a content server.

Intelligent rules for the management of the UA will be known a priori to the module.

Two advantageous embodiments of the invention can be envisaged.

In a first embodiment of the invention, depending on the availability of the network used, or else following a change in connection of the terminal from a first network connection to a second network connection of different capacity, the value of the identifier of the current navigation interface will be modified directly in the registry of the mobile terminal so that this new identifier value is the one that will be integrated into the header of the following requests sent to a server.

Depending on the type of mobile terminal used and depending on the operating system embedded in this mobile, it will be necessary to reboot the current navigation interface to take account of the new navigation interface identifier value and to activate this identifier value on the mobile terminal.

In a second embodiment of the invention, a server module is embedded in the mobile terminal. This server module plays the role of a local “proxy” whose role is to intercept any request coming from the current navigation interface and then integrate a new dynamic value of a navigation interface identifier or (“user agent”) in the headers of the requests which it must redirect towards a given server, in replacement of the static identifier value contained in the intercepted request.

These two embodiments of the invention are described in detail here below.
1. Description of the embodiment based on modification of the registry

As illustrated in FIG. 2, this first embodiment of the invention relies on the implementation, in the mobile terminal, of a set of components collaborating with each other so as to enable a modification of the static current navigation interface identifier (or user-agent) value, directly within the registry (22) of the operating system of the mobile terminal (20).

These different components are described here below for a mobile communications terminal (20) (named [T_Mob]), which has several network interfaces that it can activate, for example of the GPRS, 3G, WiFi, and other types, these interfaces being managed by a component (23) for connection to the network APIs of the operating system.

This terminal (20) therefore has available an operating system and a navigation interface (21) (named [NAV] in the figure) for which the “user-agent” (or interface identifier) is saved in a registry.

This interface (21) enables for example the terminal (20) to navigate on the Internet. This is an application executed on the terminal (20), compatible especially but not exclusively with the HTMLIWAP 2.x and prior standards.

By way of an example of a navigation interface of this kind executed by a radiocommunications mobile terminal, we may cite the Windows Pocket Explorer (registered marks) navigator which is executable on a mobile telephone as well as on a personal digital assistant (or PDA) for example.

The component (22) represents the registry on which the operating system of the terminal relies and a set of software applications that are installed in the mobile terminal (20), in the same way as the operating system stores information essential to their respective functioning.

Among the different pieces of information stored in the registry, the one of interest to an embodiment of the invention is the identifier value of the navigation interface executed by the mobile terminal. This value is defined statically by default.

An important major component implemented by an embodiment of the invention is the module (24) (named [M_Ad_UA] in FIG. 2), the role of which is to modify the static value of the “user-agent” corresponding to the navigation interface identifier, directly in the registry of the terminal (20) as a function of the level of availability of the communications network used at a given point in time and consistently with a set of a predefined rules (25).

This module (24) for adaptation of the current value of the “user-agent” therefore works with at least two other important modules of the terminal:
the module (23) named [API_NETWORK] in FIG. 2, whose function is to interact with the communications network layers that can be accessed by the operating system so as to detect that communications network which is used at a given point in time and by the mobile terminal, the switching of the mobile terminal from a first communications network to a second network during the movement of the terminal and then, for the communications network effectively used by the terminal, its level of availability in terms of bandwidth and/or bit rate, possibly as a function of the types of data asked for in the requests of the terminal transmitted to the contents server; and
the module (25) named [M_Mod_UA] in FIG. 2, whose role is to determine, for a given level of availability (with respect to available bandwidth, connection jitter, error rate for example), detected at a given point in time by the module (23), the most adapted navigation interface identifier value (or “user-agent”) that the adaptation module (24) of the “user-agent” must save in the registry of the mobile terminal so that this value is taken into account in all the headers of the requests sent to the contents server.

The modification rules (25) specify the value by which and the circumstances in which the “user-agent” must be modified.

These modification rules (25) are created at the user's initiative for example when installing the main adaptation module (24)[M_Ad_UA].

Choices could be proposed to the user on the type of data (WAP/HTML) used for the navigation when such and such an interface is active. Thus, in operation, the system will automatically modify the UA according to context.

The utility of this kind of technical solution according to an embodiment of the invention lies in the fact that, after modification of the value of identification of the current navigation interface of the mobile terminal, the new current identifier value would be taken into account in the header of each request (26) sent out by the terminal (20) to a content server terminal (28). This server (28) then, by means of its module (29) for detecting the value of the “user-agent”, will interpret the header of the request (26) of the terminal to extract therefrom the version (200) of the content to be sent back to the terminal in the response (27) to the request (26). More precisely, the working of the module (24) [M_Ad_UA] is as follows.

At each new DATA connection request, this module (24) interrogates (201) the module (23) [API_NETWORK] in order to know the network context in which the terminal (20) is situated. This terminal, by means of the APIs given by the operating system, sends on (201) the list of network interfaces present at the terminal (20) and distinguishes the one that is active.

With this last piece of information, the module (24) [M_Ad_UA] acts on the module (25) [M_Mod_UA] containing the rules of modification of the navigation interface identifier so that it sends all the equivalent “user-agent” to the active network connection.

By way of a simple illustrative and non-restrictive example of the type of modification rules (25), we may cite:
for a GSM/GPRS mean bit rate connection, an “EricssonT68/R101” navigation interface for a basic WAP type navigation; the value of the identifier which, in this case, is the “user-agent” is “EricssonT68/R101”;
for a WiFi/3G high-bit-rate connection, a “Mozilla/4.0” navigation interface for optimized Web navigation.

Once the new identifier reaches back to the adaptation module (24) [M_Ad_UA], the old navigation interface identifier value is replaced in the registry by the new identifier value determined as a function of the availability of the network used and the modification rules.

In terms of implementation of the technical solution according to an embodiment of the invention, and as illustrated in FIGS. 4a and 4b, the user has means available to configure the adaptation module (24) [M_Ad_UA] of his terminal, so as to be able to set the maximum limit on the downloading time which is tedious during low-bit-rate connections.

To this end, at the first start-up of the software, he enters his preferences through which it associates, for example in the form of a correspondence table, a set of categories of the network connections that can be exploited by its mobile terminal GSM DATA, GPRS, 3G, WiFi, etc. for example, respectively with the multimedia data content formats which he wishes to receive, WAP 1.0, WAP 2.0, xHTML, HTML 1.0, HTML 1.1, etc. for example.

Furthermore, he can subsequently replay this parametrizing phase and thus return subsequently to the parameters of configuration and the rules of modification of the current identifier of the navigation interface.

Thus, for example, if the DATA connection designed to enable the retrieval of the data, sometimes of the rich multimedia type, is:
1. of the GSM DATA then, the following identifier value (“user-agent”) is associated: “EricssonT68/R101”;
2. of the GPRS DATA type then, the following identifier value (“user-agent”) is associated: “EricssonT610”;
3. of the Socle/3G/WiFi type then, the following identifier value (“user-agent”) is associated: “Mozilla/4.0”.

The module (24) for adaptation of the current identifier of the “user-agent” works permanently. It is executed as a background task in the mobile terminal, so that it can swiftly detect any change in location of the user and of is activated mobile terminal, for example a passage from a zone covered by a 3G type communications network to a zone covered by a GPRS type network.

A case of simple and illustrative use of this first embodiment of the invention may correspond to one in which a user travels by train and passes close to a major city with UMTS coverage while the remainder of his path has GPRS coverage.

In such a scenario, the user wishes to navigate on the Internet and starts the navigator of his mobile terminal before entering, in the form of a URL, the address of the Internet site in which he wishes to search for the information.

It is imagined here that the best connection that can be activated when the user sends his request for setting up a connection with the remote content server is a 3G connection which is determined by the operating system after detection of the type of communications network accessible at this point in time.

The module (24) [M_Ad_UA] of the terminal (20) then interrogates (201) the module (23) [API_NETWORK] with the aim of knowing the network adapter used at this point in time, and the module (23) sends it back a list of network interfaces present at the terminal—GSM DATA, GPRS, WIFI, 3G, for example—as well as the current navigation interface active on the mobile terminal (20)—the navigation interface on the 3G network, for example.

The adaptation module (24) [M_Ad_UA] then sends to the module (25) [M_Mod_UA] the type of network connection available obtained from the APIs module (23), where the module (25) selects the navigation interface identifier value most adapted to this available network connection, in questioning a correspondence table defining a set of modification rules.

The module (24) [M_Ad_UA], at regular time intervals, interrogates the module (23) for management of the network APIs and then the module (25) [M_Mod_UA], from which it obtains, for example in return (202), the “Mozilla/4.0” identifier value which it has just recorded (203) in registry in the properties of the navigator.

The module (25) [M_Mod_UA] is therefore acted upon by the module (24) [M_Ad_UA] to obtain the best correspondence between the string of characters defining the network interface type and the value of the “user-agent” serving to determine the new navigation interface to be activated consistently with the availability of the detected network, for example:
for a “GSM DATA” connection, the interface identifier value is of the “Nokia7250/1.0 (3.12), Profile/MIDP-1.0, Configuration/CLDC-1.0 (Google WAP Proxy/1.0)” type;
for a “GPRS” connection, the interface identifier value is of the “Mozilla/4.0” compatible type; MSIE 4.01; Windows CE; PPC; 240×320)>>type;
for a “CRADDLE” connection, an interface identifier value of the “Mozilla/5.001 windows; U; NT4.0; Gecko/25250101” type for example.

In the meantime, the terminal (20) sets up its DATA connection which, as soon as it is activated, enables the navigator (21) to create the header of the HTTP request (26) with the values recorded in the registry which it will have come to seek (204).

The request (26) is then analyzed by the module (29) for detection of the navigation interface identifier Value [M_Det_UA] of the contents server (Web server) which extracts the value of the UA therefrom and returns (27) the HTML version (the richest and costliest in terms of bandwidth in this case).

It is imagined that thereafter, in this example, during navigation on the Internet, the user leaves the zone 3G with a high level availability of bandwidth and/or availability of bit rate, for a GPRS zone offering lower network capacities.

As above, the user wishes to continue to navigate on the Internet. This time, the connection that can be activated is the GPRS DATA connection.

The module (24) [M_Ad_UA] searches for the new interface identifier value of the “user agent” to be recorded in registry, as a function of the level of availability of the GPRS DATA network (for example the following value “EricssonT610”), this interface identifier value having to be the one best adapted to a WAP navigation format that is less rich in terms of multimedia content but consistent with the constraints of availability of the communications network used at a given point in time.

The new request (26) sent to the web server containing the new identifier value of the new current navigation interface (21) active on the mobile terminal (20) enables the module (29) for detecting the user-agent on the web server side to send back contents in the WAP format best adapted to the bit rate of the transport layer available and no longer in the HTML format.

Depending on the type of mobile terminal used, it may prove to be necessary to reboot the current navigation interface so that it adapts to the new navigation interface identifier value.

2. Description of the embodiment implying a dynamic modification of the navigation interface identifier value

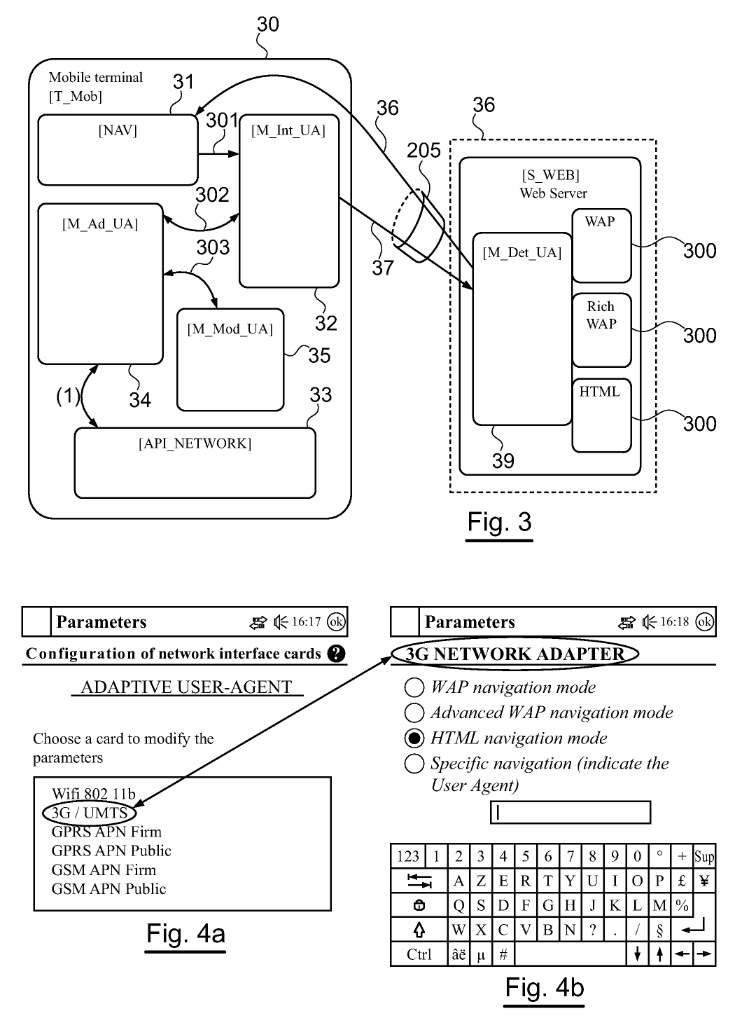

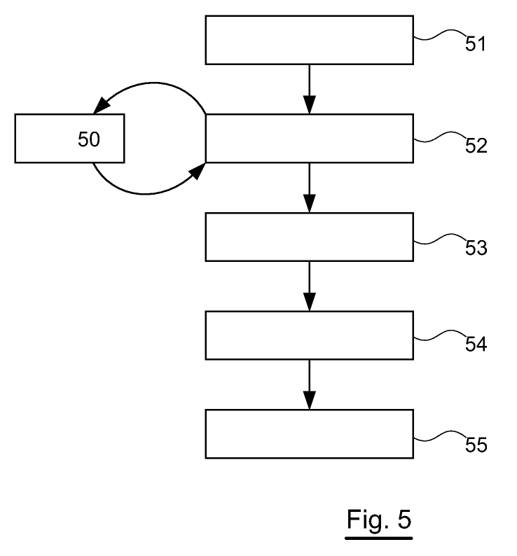

As illustrated in FIG. 3, this second embodiment of the invention relies on the implementation, at the mobile terminal, of a set of components working with one another so as to enable a modification of the static current navigation interface identifier (or “user-agent”) value but without going through a modification of the value of the navigation interface identifier of the mobile terminal (30).

As in the context of the first embodiment, we retrieve the components (30) [T_Mob] representing a mobile terminal having available several network interfaces for example GPRS, 3G, WiFi, an operating system and a navigator for which the value of the current “user-agent” is saved in a registry of the terminal (30).

The adaptation module (34) [M_Ad_UA] interacts with several elements, including the module (33) [API_NETWORK] which interacts with the network layers of the operating system.

The module (35) [M_Mod_UA] always has the role of translating information on the type of network transport into an adapted “user-agent” value.

In this second advantageous embodiment of the invention, a new module (32) [M_Int_UA] for the interception of requests sent by the navigation interface of the mobile terminal (30) is implemented.

It enables the interception and the dynamic, and no longer static, modification, if necessary of the current value of the “user-agent” contained in the http requests.

This module (32) therefore listens constantly to the outgoing http calls emitted in the form of requests by the current navigation interface. When the navigator makes a request (36) to an Internet site, it sends a header containing the information on the terminal and the navigator, including the “user-agent”.

This module (32) then, if need be, replaces the current value of the “user agent” contained in the header of each request sent by the navigation interface (31) with a value indicated to it beforehand by [M_Ad_{—UA].}

The working of the module (34) [M_Ad_UA] for adaptation of the value of the “user-agent” is specified here .

This module (34) interrogates the module (33) [API_NETWORK] in order to know the network context in which the terminal (30) is located. The module (33) having information available by means of the APIs given by the operating system sends back the module 34 the list of the network interfaces present—GSM DATA, GRPS, 3G, WIFI—on the terminal and identifies the one that is active.

The active connection is a current connection used by the terminal at a given point in time in a given context (as a function of the available network(s)) and enables the applications to access the Internet.

With this last piece of information, the module (34) [M_Ad_UA] interrogates (303) the module (35) [M_Mod_UA] so that it sends it back (303) the “user-agent” value best suited to the current network connection, for example:
for a GSM connection, the interface value intended for WAP format navigation is “EricssonT68/R101”;
for a GPRS connection, an “EricssonT610” interface authorizing for example navigation in the “graphic” WAP format;
for a WiFi/3G connection, a “Mozilla/4.0” interface for a richer HTML navigation.

Then, and once it been sent back to the module (34) [M_Ad_UA], the new value of the “user-agent” is transmitted (302) by it to the request-interception module (32) [M_Int_UA] which, as soon as an http request comes from the navigator (31), will intercept it and replace the static value of the UA contained in the header of the request, by the new dynamic value of the navigation interface identifier (or “user-agent”).

Unlike in the case of the first embodiment of the invention described in section 6.1, in this second embodiment of the invention, the current value of the navigation interface identifier can be modified directly and dynamically without its being necessary to reboot. This furthermore makes the overall architecture of the mobile terminal perfectly independent of the structure of the registry and hence of the operating system.

An embodiment of the invention provides a technique to adapt the behavior of a mobile terminal in terms of access to a contents server, and navigation on Web sites hosted by such a contents server, for example of the multimedia type, according to the capacity of the available communications network.

An embodiment of the invention enables the user of a mobile terminal to receive contents of varying volume depending on whether it has a good or poor network connection depending on its given geographical connection or again on the progress of its geographical location entailed in the movement of the user of the mobile terminal.

An embodiment of the invention provides a technique that is as transparent as possible for the user, while at the same time offering him a rendering of the content requested from the content server that is perfectly adapted to the constraints of availability of the network used at a given point in time.

An embodiment of the invention provides a technique of this kind that enables the automatic modification of the multimedia content format that the mobile terminal will receive following the transmission of each of its requests to a server according to the nature of the DATA transport layer that will be available.

An embodiment of the invention provides a technique of this kind that is relatively simple to implement and is of a reasonable cost.

An embodiment of the invention provides a technique of this kind that is adaptable to any type of communicating mobile terminal having various capacities of navigation and display, and various network access capacities.

Although the present disclosure has been described with reference to one or more examples, workers skilled in the art will recognize that changes may be made in form and detail without departing from the scope of the disclosure and/or the appended claims.

1. A method of modifying a service mode requested by a communications and/or broadcasting terminal, said terminal being connected to a communications network with variable quality of service,
wherein said terminal, prior to transmission of at least certain of its requests, executes at least:
a step of selecting a new identifier value of the desired service mode; and
a step of integrating, in a content of the request to be transmitted, said identifier value of said desired service mode,
so that signals requested by said terminal are adapted to a format corresponding to said identifier value contained in said request.

2. The method of modifying the service mode requested by a communications and/or broadcasting terminal according to claim 1, wherein said selecting step takes account of at least one parameter of configuration of said terminal defined by a user.

3. The method of modifying the service mode requested by a communications and/or broadcasting terminal according to claim 1, wherein said selecting step takes account of the value of at least one parameter representing quality of a connection of the terminal to said network, belonging to the group comprising at least:
bandwidth of said network;
jitter of said network;
maximum bit rate of said network;
mean error rate of a link.

4. The method of modifying the service mode requested by a communications and/or broadcasting terminal according to claim 3, wherein the value of at least one parameter representing the quality of the connection of said terminal to said network is detected by said terminal or is detected by another remote terminal belonging to the group comprising at least:
a contents server;
a web server;
a network traffic supervision terminal.

5. The method of modifying the service mode requested by a communications and/or broadcasting terminal according to claim 3, wherein the method comprises:
in addition, a step of detecting the current value of at least one of said parameters representing the quality of the connection of said terminal to said network;
and said step of selecting a new identifier value of said desired service mode is then adapted to said current value of said at least one network parameter detected, when said identifier value of said service mode is different from the identifier value of an active service mode in a list of service modes that can be activated and used by said terminal, said list setting up a correspondence of ranges of values associated with at least certain of the network parameters with an identifier value of a service mode adapted to these ranges of values,
said new identifier value of said selected service mode being then integrated into the content of the request to be transmitted to said server, at said integration step,
so that a response received from said terminal, following sending of at least certain of its requests, is adapted to said new selected identifier value.

6. The method of modifying the service mode requested by a communications and/or broadcasting terminal according to claim 1, wherein the step of selecting a new identifier value of the desired service mode comprises a sub-step of replacing a current navigation interface identifier value of said terminal by a new navigation interface value adapted to said new identifier value of the service mode.

7. The method of modifying the service mode requested by a communications and/or broadcasting terminal according to claim 6, wherein said sub-step of replacing is a sub-step of replacement in a registry of said terminal of said current navigation interface identifier value by said new navigation interface identifier value.

8. The method of modifying the service mode requested by a communications and/or broadcasting terminal according to claim 6, wherein the method comprises an additional step of rebooting the navigation interface of said terminal so as to activate said new navigation interface identifier value and be able to integrate this value into the content of the request to be transmitted to said server.

9. The method of modifying the service mode requested by a communications and/or broadcasting terminal according to claim 1, wherein said step of integrating said identifier value of said desired service mode into the content of the request to be transmitted is done in real time by a server module embedded in said terminal, said server module having preliminarily intercepted the at least one request, prior to the transmission of this request by said terminal to said server,
so that the format of a response of said server to said terminal is adapted to said new identifier value of the desired service mode.

10. The method of modifying the service mode requested by a communications and/or broadcasting terminal according to claim 1, wherein said step of selecting of a new identifier value of the desired service mode comprises a sub-step of taking account of a set of predefined modification rules defining modalities of replacement of said identifier value of the current service mode by said new identifier value of the service mode as a function of at least one service use parameter defined preliminarily by a user of said terminal.

11. A device for modifying the service mode requested by a communications and/or broadcasting terminal, said terminal being connected to a communications network with variable quality of service and comprising means of transmission of requests to a distant server,
wherein said device comprises at least the following means:
of selection of a new identifier value of the desired service mode; and
of integration, in a content of the request to be transmitted, of said identifier value of said desired service mode,
so that signals requested by said terminal are adapted to a format corresponding to said identifier value contained in each request of said terminal.

12. The device for modifying he a service mode requested by a communications and/or broadcasting terminal, according to claim 11, wherein said selection means comprise means for taking account of at least one parameter of configuration of said terminal defined by a user.

13. The device for modifying the service mode requested by a communications and/or broadcasting terminal, according to claim 11, wherein said selection means comprise means for taking account of the value of at least one parameter representing quality of a connection of the terminal to said network, belonging to the group comprising at least:
bandwidth of said network;
jitter of said network;
maximum bit rate of said network;
mean error rate of a link.

14. The device for modifying the service mode requested by a communications and/or broadcasting terminal, according to claim 13, wherein the device comprises additional means:
of detection of the current value of at least one of said parameters representing the quality of the connection of said terminal to said network;
of selection of a new identifier value of said desired service mode adapted to said current value of at least one of the network parameters detected, when said identifier value of said service mode is different from the identifier value of an active service mode, in a list of service modes that can be activated and used by said terminal, said list setting up a correspondence of ranges of values associated with at least certain of said network parameters with an identifier value of a service mode adapted to these ranges of values;
of integration, in the content of the request to be transmitted to said server, of the new identifier value of said selected service mode,
so that a response received from said terminal following sending of certain of its requests is adapted to said new selected identifier value.

15. The device for modifying the service mode requested by a communications and/or broadcasting terminal, according to claim 13, wherein said means of selection of a new identifier value of the desired service mode comprise means of replacement of a current navigation interface identifier value of said terminal by a new navigation interface value adapted to said new identifier value of the service mode.

16. The device for modifying the service mode requested by a communications and/or broadcasting terminal, according to claim 15, wherein said means of replacement of said interface identifier value comprise means of replacement, in a registry of said terminal, of said current navigation interface identifier value by said new navigation interface identifier value.

17. The device for modifying the service mode requested by a communications and/or broadcasting terminal, according to claim 11, wherein the device furthermore comprises self-adaptive means of configuration of said new identifier value of the desired service mode as a function of a current value of at least one parameter representing quality of a connection of said terminal to said network.

18. A communications and/or broadcasting terminal comprising a plurality of service modes that can be activated and/or a plurality of communications interfaces with at least one contents server, through a communications network, wherein the terminal implements the device for modification of the current service mode according to claim 11.

19. A computer program product recorded in a computer-readable carrier and executable by a processor comprising program code instructions for the execution of the following steps of a method of modifying a service mode requested by a communications and/or broadcasting terminal, said terminal being connected to a communications network with variable service quality, when said program is executed on a computer;
prior to transmitting at least certain of the terminal's requests,
selecting a new identifier value of the desired service mode; and
integrating, in a content of the request to be transmitted, said identifier value of said desired service mode,
so that signals requested by said terminal are adapted to a format corresponding to said identifier value contained in said request.

20. Application of the method of modification of the service mode requested by a communications and/or broadcasting terminal according to claim 1 to a field belonging to the group consisting of:
videotelephony;
computer-assisted collaborative work;
embedded communicating applications;
messaging services;
television on demand;
video on demand.
